(19) United States
(12) Patent Application Publication
(10) Pub. No.: US 2004/0107582 A1
(43) Pub. Date: Jun. 10, 2004

(54) Cutter blade with reduced resistance

(76) Inventor: Pascal Jodas, Orleat (FR)

Correspondence Address: CANTOR COLBURN, LLP, 55 GRIFFIN ROAD SOUTH, BLOOMFIELD, CT, 06002

(21) Appl. No.: 10/473,110

(22) PCT Filed: Mar. 22, 2002
(86) PCT No.: PCT/FR02/01015

(30) Foreign Application Priority Data
Mar. 30, 2001 (FR) 01/04606

(51) Int. Cl. B26B 13/00

(52) U.S. Cl. 30/249; 30/254

(57) ABSTRACT

The invention concerns a A pair of shears with reduced resistance is disclosed including comprising two levers articulated on a hinge forming a cross with, on one side, two shanks capable of being brought together manually, and on the other side, a cutting blade and a cutting block or hook. The invention is characterized in that the blade comprises includes, in at least one of its two side surfaces penetrating into the plant branch object being cut, several grooves spaced away from the cutting edge, extending over its a zone urged in contact with the wood object, emerging at least through their proximal end from said the cutting edge, said the grooves a) alternating with spans, b) having a depth and a width enabling them to form in fibers of the wood cut by the cutting edge a notched part inverse to that of the blade, and c) having a direction such that, when the blade is closed against the cutting block and hook, the notch formed in the surface at the tip of at least part of the cut fibers are urged to be pressed by its apices on the spans on the grooves of the blade, thereby reducing the surface of the weed object in contact with the blade.

The invention relates to secateurs and refers, in particular, to those intensively used by viticulturalists, horticulturalists, nursery gardeners and other trades in which plants are pruned.

A secateur is composed of two levers articulated one upon the other to form a cross and having, on one side of their articulation, two arms which can be manually brought together and, on the other side, a cutting blade, having a curved cutting edge, and a counter-blade or hook. By virtue of its structure, it differs from shears such as those described in document U.S. Pat. No. 5,267,400. Its functioning is also different, since it acts by cutting, that is to say by penetration of its blade into the wood, whereas the shears act by shearing, that is to say by two opposite cutting forces acting in a same severing plane.

In a secateur, the resistance acting upon the blade and the hook goes from a zero value to a maximum value, then gradually declines up to the division of the branch of the plant. The manual force needing to be applied to the arms of the secateur depends on the diameter of the branch of the plant, its degree of humidity and the nature of the wood. It can reach a value in the order of 17 decanewtons. The repetition of such high effort in the course of a working day can lead to muscular injuries and, for example, to cases of tendinitis.

The object of the present invention is to remedy these drawbacks by providing a secateur which allows a reduction in the value of the manual force needing to be applied to the branches and, consequently, a lessening of the muscular fatigue of the operator and the risks of injuries.

To this end, in the secateur according to the invention, the blade comprises, in at least one of its two side faces penetrating into the branch of the plant, a plurality of grooves, which run away from the curved and continuous cutting edge, extend over the whole or part of the width of its zone entering into contact with the wood, emerge at least by their end close to this cutting edge and have their bottom flush with the cutting edge without affecting the continuity thereof, these grooves a) alternating with webs or ridges, b) having a depth and width allowing them to form in the wood fibers severed by the cutting edge a serration inverse to that of the blade, and c) having a direction such that, when the blade is closed against the hook, the serration formed in the face at the end of at least a part of the severed fibers comes to rest by its tips upon the webs between grooves of the blade, thereby reducing the surface area of the wood in contact with the blade.

Thus, the friction forces are reduced to the benefit of the cutting force, such that, for the same resistance, the manual force needing to be provided is thus reduced.

In one embodiment, the grooves of the blade are formed on the top face of this blade.

This arrangement does not complicate the manufacture of the secateur and does not affect the severance of the branches, since the blade has a continuous cutting edge extended by a plane and smooth surface ensuring the perfect cutting edge.

Other characteristics and advantages will emerge from the following description with reference to the appended schematic diagram representing several embodiments of the secateur according to the invention.

FIG. 1 is a projected side view of a secateur according to the invention,

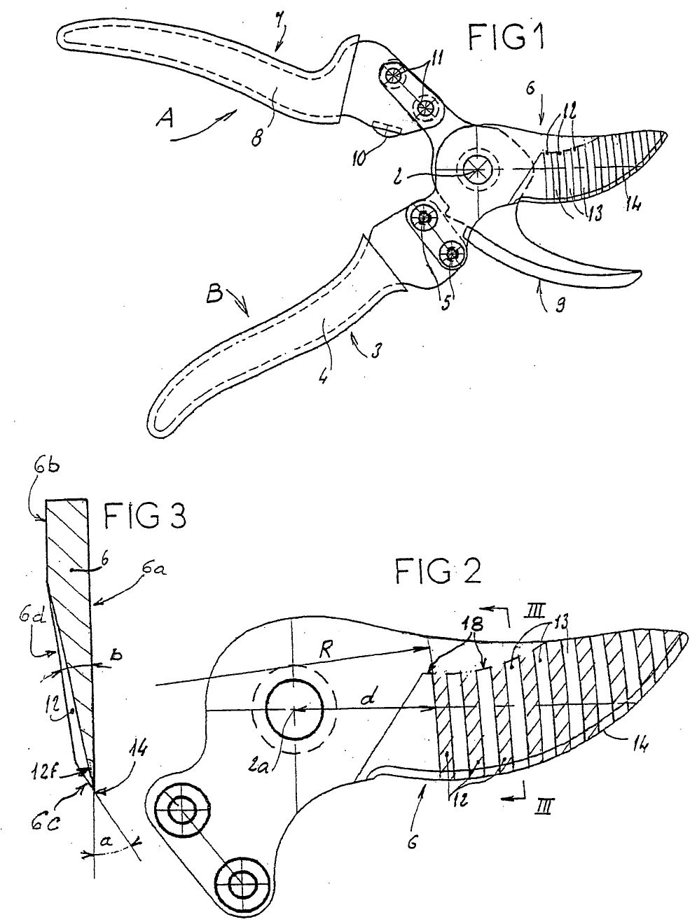

FIG. 2 is a projected side view, on an enlarged scale, of the blade of the secateur of FIG. 1,

FIG. 3 is a sectional view, on an enlarged scale, along the line III-III of FIG. 2,

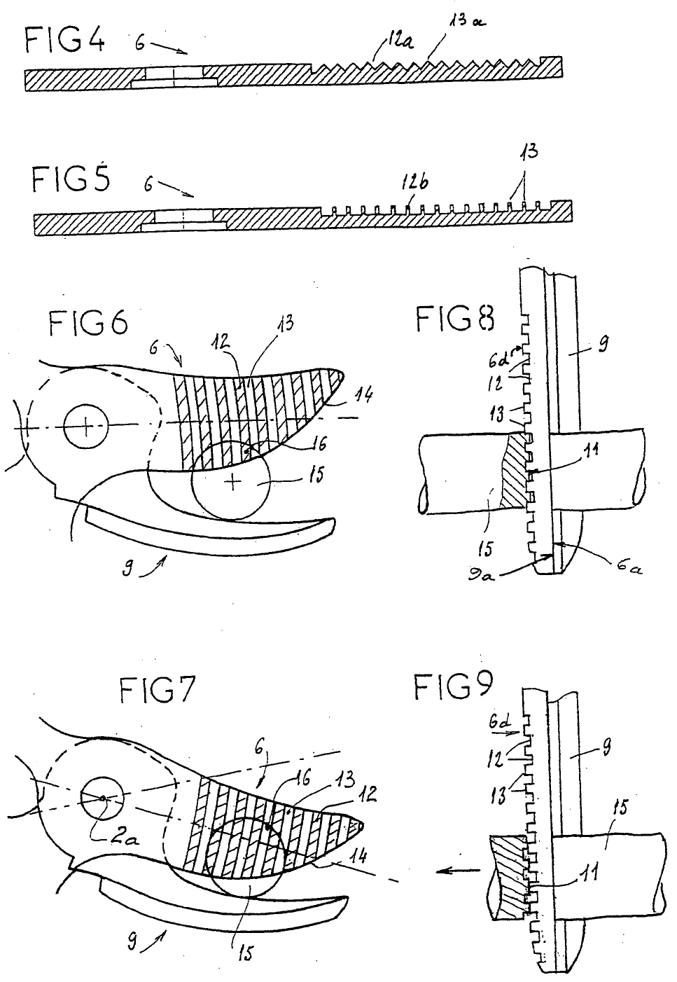

FIGS. 4 and 5 are side views, in longitudinal section, of two embodiments of a blade,

FIGS. 6 and 7 are partial side views showing two of the cutting phases of a branch by the secateur,

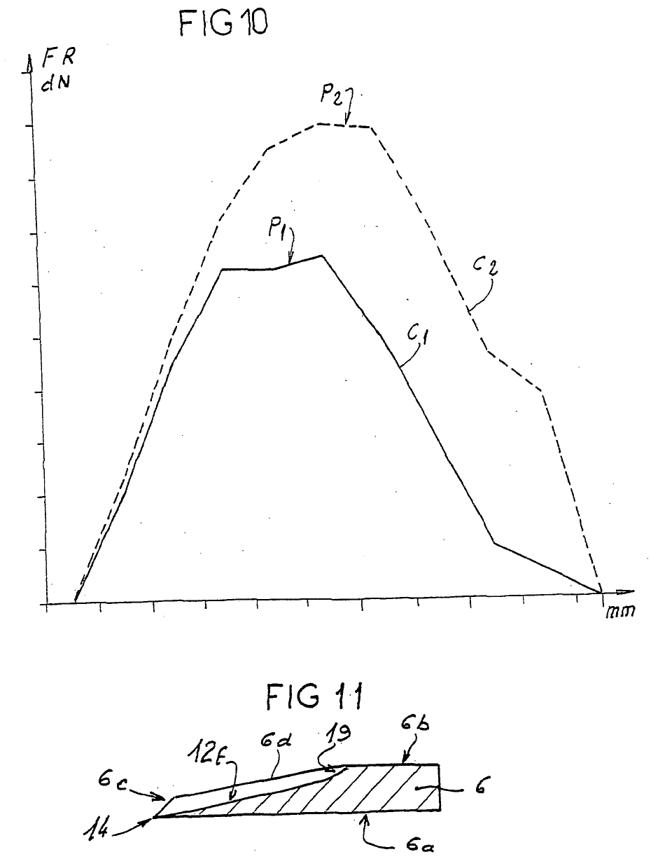

FIGS. 8 and 9 are top views of the secateur when it is in the position of FIGS. 6 and 7 respectively,

FIG. 10 is a graph representing the variation in force on the blade as a function of the closing travel,

FIG. 11 is a sectional view similar to FIG. 3, showing a different embodiment of the grooves.

The secateur, represented in FIG. 1, is composed of two levers A and B, articulated one upon the other about an articulation axis 2 to form a cross. The lever A is composed of an arm 3 with grip 4, on which arm is fixed, by two screws 5, an interchangeable blade 6.

The lever B is composed of an arm 7 with grip 8. This arm is joined to a counter-blade or hook 9. The hook 9 is likewise interchangeable and is fixed on the arm 7 by two screws 11. The arm 7 is provided, projecting from its face turned toward the arm 3, with a stop 10.

As shown in FIG. 3, the blade 6 is delimited between a face 6a, sliding against a complementary face 9a of the hook 9, FIG. 8, and a so-called “top” face composed of:

a face 6b, parallel to the face 6a,

a cutting edge face 6c, forming with the face 6a the angle a of cutting and the cutting edge 14,

and, finally, a disengagement face 6d, forming with the face 6a a lesser angle b.

The face 6d has a line of greater inclination which remains substantially perpendicular to the curved and continuous cutting edge 14 and forms, with the face 6b, an edge 18 substantially parallel to the cutting edge 14.

In the represented embodiment and as shown in greater detail in FIG. 2, the blade 6 comprises, in its top face 6c-6d, grooves 12, which are mutually parallel and which alternate with non-grooved webs 13. In order to make them easier to identify, the grooves are hatched on the appended drawing.

These grooves 12 extend over a part of the width of the zone of the blade 6 which enters into contact with the wood of a branch and, for example, from the cutting edge 14 to the edge 18, but in another embodiment they can extend over the whole of the width of this zone and even, indeed, of the blade. As shown in FIG. 3, they are emergent at each of their ends, including toward the cutting edge 14, where their bottom 12f lies flush with this edge without creating a notch in the latter, that is to say without affecting its continuous and curved character.

According to the embodiments, the grooves can have a transverse section which, as shown at 12a in FIG. 4, is triangular and is separated from its neighbors by ridges 13a, as shown in 12b in FIG. 5, is rectangular and is separated from its neighbors by webs 13, or can be in any other form provided that their dimensions, width and height, and their distribution, allow a serration 11, visible in FIGS. 8 and 9, to be formed in the wood fibers.

In FIG. 2, the grooves 12 are not perpendicular to the cutting edge 14 but are in the form of a circular arc having a radius R, the value of which is greater than that of their radial distance d to the geometric axis 2a of the articulation axis 2 of the blade.

In other embodiments, these grooves are rectilinear and tangential to a circle centered on the geometric axis 2a, or are curved, with a concavity inverse to that represented in FIG. 2.

Finally and according to the adopted machining method, the bottom 12f of each groove 12 can be rectilinear, as shown in FIG. 3, or can be rectilinear then pass into a fillet 19, as shown in FIG. 11, without this influencing the functioning of the secateur.

The functioning of the secateur is given with reference to FIGS. 6 to 9, of which FIGS. 8 and 9 are very schematic and on a very enlarged scale in order better to illustrate this functioning.

When a secateur bearing the blade 6 with grooves of rectangular section is used to sever a branch 15, those fibers of the branch which come into contact with the top of the blade distribute themselves, as shown in FIG. 6, between the grooves 12 and the webs 13 and form, as shown in FIG. 8, a serration 11, which is the inverse of that formed in the blade. By virtue of the non-concentricity of the grooves with the center of rotation 2a of the blade 6 and the continued pivoting motion of this blade, at least certain of the wood fibers which have penetrated into a groove 12, as marked for the point 16 in FIG. 6, enter into contact with a web 13 between grooves, as shown in FIG. 7 for the point 16. This staggering of the serration 11 formed in the branch in the course of severance, relative to that serration formed on the top of the blade, reduces the surface areas in contact and, consequently, the value of the resistance generated by the friction of the wood on the blade.

The graphic of FIG. 10 giving, in ordinates, the value in decanewtons of the resistance FR when a 22 mm branch of hazel tree is cut, and in abscissas, the closure travel of the blade in millimeters, shows that the curve of resistance C1 obtained with a grooved-blade secateur has the same trend, but has a plateau P1 of lesser value than that P2 of the curve C2, obtained with a normal secateur used under the same conditions. The improvement is in the order of 30 to 35% with triangular grooves having rounded ridges.

In other words, the presence of grooves 12 in one of the faces of the blade 6 allows a reduction in the resistance and, consequently, in the manual force needing to be applied to the arms 3 and 7 of the secateur, with the advantage of reducing the fatigue of the user.

In one construction variant (not shown), the grooves are realized in the inner side face 6a of the blade, that is to say in the face which slides against the inner side face 9a of the hook 9. It is likewise possible to produce grooves on the two faces of the blade 6.

1. A reduced-resistance secateur, comprising two levers (A and B) articulated one upon the other by an articulation (2) to form a cross and having, on one side, two arms (3, 7) which can be manually brought together and, on the other side, a cutting blade having a curved cutting edge (6) and a hook (9), characterized in that the blade (6) comprises, in at least one of its two side faces penetrating into the branch of the plant, a plurality of grooves (12), which run away from the curved and continuous cutting edge (14), extend over the whole or part of the width of its zone entering into contact with the wood, emerge at least by their end close to this cutting edge and have their bottom flush with the cutting edge without affecting the continuity thereof, these grooves a) alternating with webs (13) or ridges (13a), b) having a depth and width allowing them to form in the wood fibers severed by the cutting edge a serration inverse to that of the blade, and c) having a direction such that, when the blade (6) is closed against the counter-blade or hook (9), the serration formed in the face at the end of at least a part of the severed fibers comes to rest by its tips upon the webs (13, 13a) between grooves of the blade (3), thereby reducing the surface area of the wood in contact with the blade.

2. The secateur as claimed in claim 1, characterized in that the grooves (12) of the blade are formed on the top face of the blade (6).

3. The secateur as claimed in claim 1, characterized in that the grooves are formed in the inner face of the blade (6), sliding against the inner face of the counter-blade.

4. The secateur as claimed in claim 1, characterized in that the transverse section of each groove (12) is triangular.

5. The secateur as claimed in claim 1, characterized in that the transverse section of each groove (12) is rectangular.

6. The secateur as claimed in claim 1, characterized in that the grooves (12) are rectilinear and tangential to a circle centered on the articulation axis (2).

7. The secateur as claimed in claim 1, characterized in that the grooves (12) are in the form of a circular arc and have a radius R, the value of which is greater than the value of their radial distance (d) to the geometric axis (2a) of the articulation (2) of the blade (6).
